(19) United States
(12) Patent Application Publication
(10) Pub. No.: US 2026/0313216 A1
(43) Pub. Date: Oct. 8, 2026

(54) CAMERA MODULE

(71) Applicant: SAMSUNG ELECTRO-MECHANICS CO., LTD., Suwon-si (KR)

(72) Inventors: Bo Sung SEO, Suwon-si (KR); Nam Ju LEE, Suwon-si (KR); Young Bok YOON, Suwon-si (KR)

(73) Assignee: SAMSUNG ELECTRO-MECHANICS CO., LTD., Suwon-si (KR)

(21) Appl. No.: 19/573,319

(22) Filed: Mar. 20, 2026

(30) Foreign Application Priority Data
Apr. 8, 2025 (KR) 10-2025-0045664
Nov. 18, 2025 (KR) 10-2025-0174282

(51) Int. Cl. H04N 23/55; G02B 7/09; G02B 27/64

(52) U.S. Cl. CPC H04N 23/55; G02B 7/09; G02B 27/646

(57) ABSTRACT

A camera module includes a housing, a carrier disposed on the housing and configured to move in a first direction with respect to the housing, a prism holder disposed on the carrier and configured to move in a second direction perpendicular to the first direction with respect to the carrier, a lens module disposed on the prism holder and configured to move in a third direction perpendicular to the first and second directions with respect to the prism holder.

### CROSS-REFERENCE TO RELATED APPLICATIONS

This application claims the benefit under 35 USC 119(a) of Korean Patent Application Nos. 10-2025-0174282 filed on Nov. 18, 2025, and 10-2025-0045664 filed on Apr. 8, 2025, in the Korean Intellectual Property Office, the entire disclosures of which are incorporated herein by reference for all purposes.

### BACKGROUND

### 1. Field

The present disclosure relates to a camera module.

### 2. Description of the Background

A camera module may be employed in portable electronic devices such as a smartphone, a tablet PC, and a laptop.

A camera module in which an optical path may be folded by disposing a reflective member in front of a lens module may be used to reduce a size and a thickness of a portable electronic device.

A camera module may include an optical image stabilization (hereinafter, OIS) function to prevent a camera from shaking during imaging to enhance resolution, and this function may be implemented through rotation of a reflective member.

Also, a lens module included in a camera module may be driven for autofocusing (hereinafter, AF).

However, as OIS operation of a reflective member and AF operation of a lens module are performed independently, errors may occur during control and a size of the camera module may increase.

Accordingly, there may be a desire for a camera module having a structure advantageous for miniaturization while improving accuracy of OIS and AF driving control.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing, a carrier disposed on the housing and configured to move in a first direction with respect to the housing, a prism holder disposed on the carrier and configured to move in a second direction perpendicular to the first direction with respect to the carrier, a lens module disposed on the prism holder and configured to move in a third direction perpendicular to the first and second directions with respect to the prism holder.

The lens module may include a lens barrel including at least one lens aligned in the third direction, and a lens holder on which the lens barrel may be mounted.

The housing may include a first guide groove formed on a surface facing one surface of the carrier, wherein the carrier may include a second guide groove facing the first guide groove, and wherein a first ball member may be disposed between the first guide groove and the second guide groove.

The first guide groove may be disposed as a plurality of first guide grooves and the second guide groove may be disposed as a plurality of second guide grooves, and each of the plurality of first guide grooves and the plurality of second guide grooves may have a shape extending in the first direction, and lengths in the first direction of the plurality of first guide grooves may be different from each other.

The camera module may further include a first driver configured to move the carrier in the first direction, wherein the first driver may include a first coil disposed in the housing, and a first magnet disposed in the carrier to face the first coil.

The plurality of second guide grooves may be spaced apart from each other in the third direction on both sides of the carrier with respect to the first magnet on the one surface of the carrier, and a number of second guide grooves disposed on one side with respect to the first magnet and a number of second guide grooves disposed on another side may be different.

With respect to the first magnet, the one side of the carrier may be adjacent to the prism holder, and the other side of the carrier may be adjacent to the lens, and the number of the second guide grooves disposed on the one side of the carrier may be greater than the number of the second guide grooves disposed on the other side of the carrier.

The prism holder may include a mounting portion in which a reflective member may be disposed, and an extension portion extending from the mounting portion in the third direction and facing the lens module.

The carrier may include a third guide groove formed on a surface facing the prism holder, the prism holder may include a fourth guide groove facing the third guide groove, and a second ball member may be disposed between the third and fourth guide grooves.

The third guide groove may be disposed as a plurality of third guide grooves and the fourth guide groove may be disposed as a plurality of fourth guide grooves, and each of the plurality of third guide grooves and the plurality of fourth guide grooves may have a shape extending in the second direction.

The camera module may further include a second driver configured to move the prism holder in the second direction. The second driver may include a second coil disposed in the carrier, and a second magnet disposed in the prism holder to face the second coil.

The second ball member may be disposed as a plurality of second ball members, the plurality of fourth guide grooves may be spaced apart from each other on both sides in the first direction with respect to the second magnet on one surface of the prism holder, and a number of second ball members disposed in the fourth guide groove on one side with respect to the second magnet may be greater than a number of second ball members disposed in the fourth guide groove on another side.

The extension portion may include a fifth guide groove formed on a surface facing the lens module, the lens module may include a sixth guide groove facing the extension portion, and a third ball member may be disposed between the fifth guide groove and the sixth guide groove.

The fifth guide groove may be disposed as a plurality of fifth guide grooves and the sixth guide groove may be disposed as a plurality of sixth guide grooves, and each of the plurality of fifth guide grooves and the plurality of sixth guide grooves may have a shape extending in the third direction.

The camera module may further include a third driver configured to move the lens module in the third direction. The third driver may include a third coil disposed in the extension portion, and a third magnet disposed in the lens module to face the third coil.

The third ball may be disposed as a plurality of third ball members, the plurality of fifth guide grooves may be disposed on one surface of the extension portion, spaced apart from each other in the first direction on both sides with respect to the third magnet, and a number of third ball members disposed in the fifth guide groove on one side with respect to the third magnet may be greater than a number of third ball members disposed in the fifth guide groove on another side.

In another general aspect, a camera module includes a housing, a reflective module disposed in the housing and configured to move in a first direction and a second direction perpendicular to the first direction, and a lens module configured to move in the first direction and the second direction together with the reflective module, and configured to move in a third direction perpendicular to the first direction and the second direction with respect to the reflective module.

The camera module may further include a carrier in which the reflective module is disposed, a plurality of first ball members disposed between the housing and the carrier and configured to support the carrier, a plurality of second ball members disposed between the carrier and the reflection module and configured to support the reflection module, and a plurality of third ball members disposed between the reflection module and the lens module and configured to support the lens module.

On a cross-sectional surface passing through the plurality of first ball members, a center of gravity of the carrier may be positioned within a triangle connecting centers of the plurality of first ball members.

On a cross-sectional surface passing through the plurality of second ball members, a center of gravity of the reflective module may be positioned within a triangle connecting centers of the plurality of second ball members.

On a cross-sectional surface passing through the plurality of third ball members, a center of gravity of the lens module may be positioned within a triangle connecting centers of the plurality of third ball members.

Other features and aspects will be apparent from the following detailed description, the drawings, and the claims.

### BRIEF DESCRIPTION OF DRAWINGS

FIG. 1 is a perspective diagram illustrating a camera module according to an embodiment of the present disclosure.

FIG. 2 is a perspective diagram illustrating the camera module illustrated in FIG. 1 without a case.

FIG. 3 is an exploded perspective diagram illustrating a camera module according to an embodiment of the present disclosure.

FIG. 4 is a plan diagram illustrating OIS operation in the X-axis direction and AF operation in the Y-axis direction of a camera module according to an embodiment of the present disclosure.

FIG. 5 is a cross-sectional diagram taken along line I-I’ in FIG. 1.

FIG. 6 is a diagram illustrating OIS operation in the Z-axis direction of a camera module according to an embodiment of the present disclosure.

FIG. 7 is a cross-sectional perspective diagram taken along line II-II’ in FIG. 1.

FIG. 8 is a cross-sectional diagram taken along line II-II’ in FIG. 1.

FIG. 9 is a cross-sectional diagram taken along line III-III’ in FIG. 1.

FIG. 10 is a cross-sectional perspective diagram taken along line IV-IV’ in FIG. 1.

FIG. 11 is a cross-sectional diagram taken along line IV-IV’ in FIG. 1.

FIG. 12 is a cross-sectional perspective diagram taken along line V-V’ in FIG. 1.

FIG. 13 is a cross-sectional diagram taken along line V-V’ in FIG. 1.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure may be to improve accuracy of OIS and AF operation control through a structure in which a lens module may also move during OIS operation of a reflective member.

An aspect of the present disclosure may be to easily perform optical axis alignment with a lens module by implementing OIS operation of a reflective member through linear movement instead of rotation.

An aspect of the present disclosure may be to reduce a thickness of a camera module using a structure in which OIS and AF drivers are disposed on the side surface.

The present disclosure relates to a camera module, and a camera module that may be mounted on a portable electronic device such as a mobile communication terminal, a smart phone, or a tablet PC.

A camera module 1000 according to an embodiment may include a housing 110, a carrier 400 disposed on the housing 110, a reflective module 300 disposed on the carrier 400, and a lens module 200 disposed on the reflective module 300.

Through this multilayer structure, an autofocusing (hereinafter, AF) operation of the lens module 200 may be performed dependent on an optical image stabilization (hereinafter, OIS) operation of the reflective module 300.

That is, when the carrier 400 moves in the first direction (Z-axis direction) for OIS operation of the reflective module 300, the reflective module 300 and the lens module 200 may also move in the first direction (Z-axis direction).

Also, when the reflective module 300 moves in the second direction (X-axis direction) for OIS operation of the reflective module 300, the lens module 200 may also move in the second direction (X-axis direction).

Here, the OIS operation of the reflective module 300 may be implemented by substantially linear movement of the reflective module 300 and the carrier 400, rather than rotation of the reflective module 300.

When the lens module 200 moves in the third direction (Y-axis direction) for AF operation of the lens module 200, only the lens module 200 may move in the third direction (Y-axis direction).

Through this structure, the camera module 1000 according to an embodiment may perform more swift and precise OIS and AF control than when the OIS operation of the reflective module 300 and the AF operation of the lens module 200 are performed independently.

The components and operation of the camera module 1000 according to an embodiment will be described in greater detail below with reference to the drawings. In embodiments, the first direction may be defined as the Z-axis direction in the drawings, the second direction as the X-axis direction in the drawings, and the third direction as the Y-axis direction in the drawings.

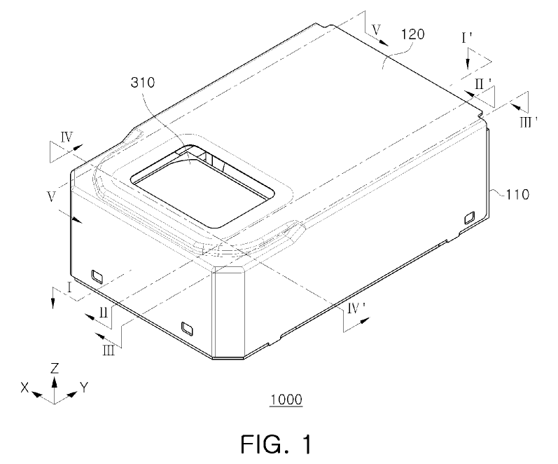

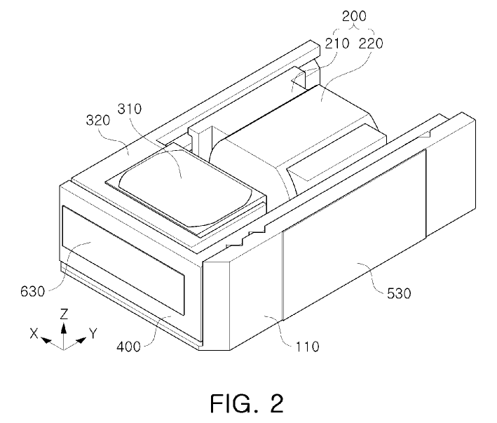

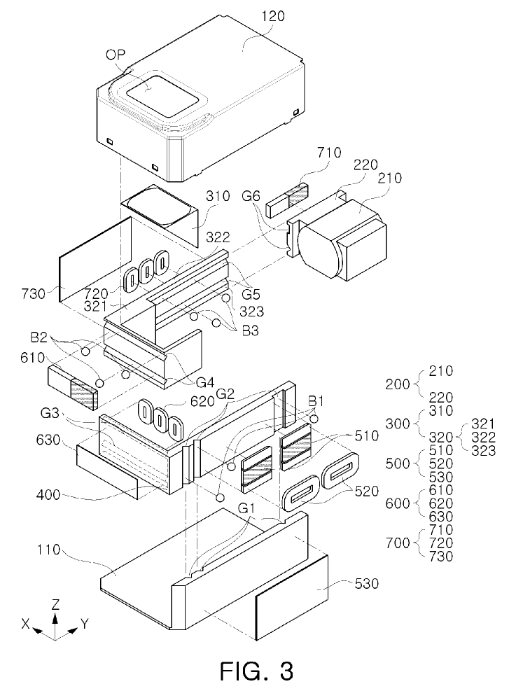

FIG. 1 is a perspective diagram illustrating a camera module 1000 according to an embodiment. FIG. 2 is a perspective diagram illustrating the camera module illustrated in FIG. 1 without a case 120. FIG. 3 is an exploded perspective diagram illustrating the camera module 1000 according to an embodiment.

Referring to FIGS. 1, 2, and 3, the camera module 1000 according to an embodiment may include a housing 110, a case 120, a lens module 200, a reflective module 300, and a carrier 400. Also, the reflective module 300 may include a reflective member 310 and a prism holder 320.

Also, the camera module 1000 may include a first driver 500 and a second driver 600 responsible for OIS operation of the reflective module 300, and a third driver 700 responsible for AF operation of the lens module 200. The first driver 500, the second driver 600, and the third driver 700 may include coils and magnets performing electromagnetic interactions, thereby precisely moving each component.

In the camera module 1000 according to the embodiment, the first driver 500, the second driver 600, and the third driver 700 may be disposed in the side region. Also, the support structures between the housing 110 and the carrier 400, between the carrier 400 and the prism holder 320, and between the prism holder 320 and the lens module 200 may also be disposed in the side region. By this structure, the thickness of the camera module 1000 may be reduced. However, an embodiment thereof is not limited thereto, and the support structure may also be disposed in the lower region of the housing 110.

The housing 110 may function as a base structure supporting the internal components of the camera module 1000. The case 120 may be coupled to an upper portion of housing 110 and may function as a cover sealing the internal portion. The housing 110 and the case 120 may be coupled to each other and may form a space protecting sensitive components, such as the lens module 200, from external impact or foreign substances. The case 120 may have an opening OP to allow external light reflected from an object to be incident on the reflective member 310. The case 120 may include a cover glass (cover lens) to seal the opening OP.

The lens module 200 may function to focus an image of a subject onto an image sensor. The lens module 200 may include a lens barrel 210 and a lens holder 220. The lens barrel 210 may include one or more lenses, and the one or more lenses may be aligned along the optical axis (Y axis in FIG. 3). The lens holder 220 may be configured to fix and support the lens barrel 210. For example, the lens barrel 210 may be fixed to the lens holder 220.

In an embodiment, the lens module 200 may be configured to move in the third direction (Y-axis direction) perpendicular to the first direction (Z-axis direction) and the second direction (X-axis direction) with respect to the prism holder 320. The lens module 200 may perform an autofocus (AF) function by moving in the third direction (Y-axis direction) by receiving driving force of the third driver 700.

In an embodiment, the reflective module 300 may include a reflective member 310 and a prism holder 320 including the reflective member 310. For example, the reflective member 310 may be disposed on the prism holder 320.

The reflective member 310 may be configured as an optical device refracting a path of externally incident light. For example, the reflective member 310 may be implemented as a prism, a mirror, or a lens. However, an embodiment thereof is not limited thereto. By folding the optical path through the reflective member 310, the overall thickness of the camera module 1000 may be reduced.

The prism holder 320 may be configured to stably fix and support the reflective member 310. The prism holder 320 may include a mounting portion 321, an extension portion 322, and a support portion 323. The mounting portion 321 may provide a space in which the reflective member 310 is seated. The extension portion 322 may extend from the mounting portion 321 in the third direction (Y-axis direction) and may face the lens module 200. The extension portion 322 may include a guide structure for movement of the lens module 200, and a third magnet 710 of the third driver 700 may be disposed therein. The extension portion 322 may be formed by extending one side of the prism holder 320, and the prism holder 320 may have an asymmetrical shape. Referring to FIG. 3, a support portion 323 for more stable support may be disposed at the end of the extension portion 322. The support portion 323 may provide supplementary support between the bottom surface of the housing 110 and the prism holder 320.

The carrier 400 may support the prism holder 320 and may be a movable body configured to move with respect to the housing 110. The carrier 400 may be configured to move in the first direction (Z-axis direction) with respect to the housing 110.

The prism holder 320 may be supported by the carrier 400 and may be configured to move in the second direction (X-axis direction) perpendicular to the first direction (Z-axis direction) with respect to the carrier 400.

Optical image stabilization (OIS) may be implemented through the linear movement of the carrier 400 and the prism holder 320, as compared to optical image stabilization (OIS) based on the rotation of the reflective module 300, optical axis alignment and other control may be more easily performed.

The camera module 1000 may include a first ball member B1 disposed between the housing 110 and the carrier 400. The first ball member B1 may be disposed as a plurality of first ball members B1. The housing 110 may include a plurality of first guide grooves G1 formed on a surface facing one surface of the carrier 400. The carrier 400 may include a plurality of second guide grooves G2 facing the first guide grooves G1. The first ball member B1 may be disposed between the first guide grooves G1 and the second guide grooves G2 and may guide the carrier 400 to move smoothly in the first direction.

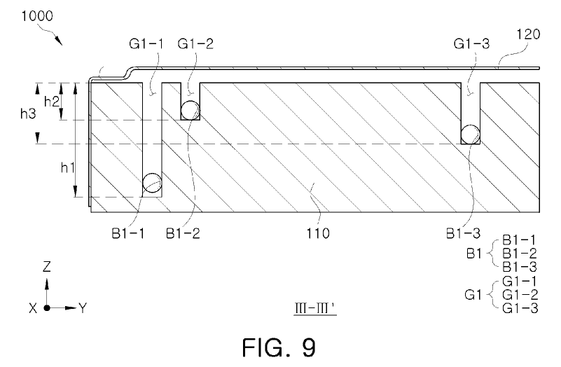

Each of the first guide grooves G1 and the second guide grooves G2 may have a shape extending in the first direction. The lengths of the plurality of first guide grooves G1 in the first direction may be different from each other, which will be described in greater detail later with reference to FIG. 9.

In an embodiment, the plurality of second guide grooves G2 may be spaced apart from each other in the third direction on both sides of the one surface of the carrier 400 with respect to a first magnet 510. The number of second guide grooves G2 disposed on one side of the one surface with respect to the first magnet 510 and the number of second guide grooves G2 disposed on the other side of the one surface with respect to the first magnet 510 may be different. For example, with respect to the first magnet 510, one side of the carrier 400 may be adjacent to the prism holder 320, and the other side of the carrier 400 may be adjacent to the lens module 200. The number of second guide grooves G2 disposed on one side of the carrier 400 may be greater than the number of second guide grooves G2 disposed on the other side of the carrier 400. For example, as illustrated in FIG. 3, two second guide grooves G2 may be formed on one side of the carrier 400 and one second guide groove G2 may be formed on the other side, but an embodiment thereof is not limited thereto.

The first driver 500 may be configured to move the carrier 400 in the first direction (Z-direction). The first driver 500 may include a first coil 520 disposed in the housing 110 and a first magnet 510 disposed in the carrier 400 to face the first coil 520. When current is applied to the first coil 520, the carrier 400 may move in the first direction (Z-direction) through electromagnetic interaction with the first magnet 510. A first yoke 530 may form a magnetic field around the first magnet 510 and the first coil 520, thereby improving driving efficiency.

The camera module 1000 may include a second ball member B2 disposed between the carrier 400 and the prism holder 320. The second ball member B2 may be disposed as a plurality of second ball members B2. The carrier 400 may include a plurality of third guide grooves G3 formed on a surface facing the prism holder 320. The prism holder 320 may include a plurality of fourth guide grooves G4 facing the third guide grooves G3. The second ball member B2 may be disposed between the third guide grooves G3 and the fourth guide grooves G4 and may guide the prism holder 320 to move linearly in the second direction.

Each of the third guide grooves G3 and the fourth guide grooves G4 may have a shape extending in the second direction. In an embodiment, the plurality of fourth guide grooves G4 may be spaced apart from each other in the first direction (Z-axis direction) on both sides with respect to a second magnet 610 on one surface of the prism holder 320. The number of second ball members B2 disposed in the fourth guide groove G4 on one side with respect to the second magnet 610 may be greater than the number of second ball members B2 disposed in the fourth guide groove G4 on the other side with respect to the second magnet 610.

The second driver 600 may be configured to move the prism holder 320 in the second direction (X-direction). The second driver may include a second coil 620 disposed in the carrier 400 and a second magnet 610 disposed in the prism holder 320 to face the second coil 620. By controlling current applied to the second coil 620, the prism holder 320 may move in the second direction (X-axis direction). A second yoke 630 may form a magnetic field around the second magnet 610 and the second coil 620, thereby improving driving efficiency.

The camera module 1000 may include a third ball member B3 disposed between the prism holder 320 and the lens module 200. The third ball member B3 may be disposed as a plurality of third ball members B3. The extension portion 322 of the prism holder 320 may include a plurality of fifth guide grooves G5 formed on a surface facing the lens module 200. The lens module 200 may include a plurality of sixth guide grooves G6 facing the extension portion 322. The third ball member B3 may be disposed between the fifth guide grooves G5 and the sixth guide grooves G6 and may support the lens module 200 to move precisely in the third direction (Y-axis direction). Each of the fifth guide grooves G5 and the sixth guide grooves G6 may have a shape extending in the third direction.

In an embodiment, the plurality of fifth guide grooves G5 may be spaced apart from each other on both sides in the first direction (Z-axis direction) on one surface of the extension portion 322 with respect to a third magnet 710. With respect to the third magnet 710, the number of third ball members B3 disposed in the fifth guide groove G5 on one side may be greater than the number of third ball members B3 disposed in the fifth guide groove G5 on the other side.

The third driver 700 may be configured to move the lens module 200 in the third direction (Y-axis direction). The third driver 700 may include a third coil 720 disposed in the extension portion 322 of the prism holder 320, and a third magnet 710 disposed in the lens module 200 to face the third coil 720. When current is applied to the third coil 720, electromagnetic force may be generated. By the generated electromagnetic force, the lens module 200 may move in the third direction (Y-axis direction), thereby performing autofocusing (AF). A third yoke 730 may form a magnetic path and may increase driving efficiency of the third driver 700.

In an embodiment, the prism holder 320 including the reflective member 310 and the lens module 200 may be supported together by the carrier 400. That is, when the carrier 400 moves in the first direction (Z-axis direction), the prism holder 320 and the lens module 200 may move together in the first direction (Z-axis direction). Also, when the prism holder 320 moves in the second direction (X-axis direction) with respect to the carrier 400, the lens module 200 may move in the second direction (X-axis direction) together with the prism holder 320. Accordingly, when optical image stabilization (OIS) is operated, the lens module 200 may move together with the reflective member 310, thereby ensuring stability of optical axis alignment and improving control accuracy.

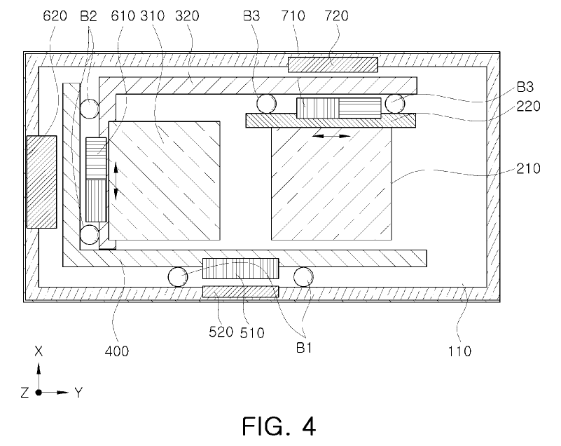

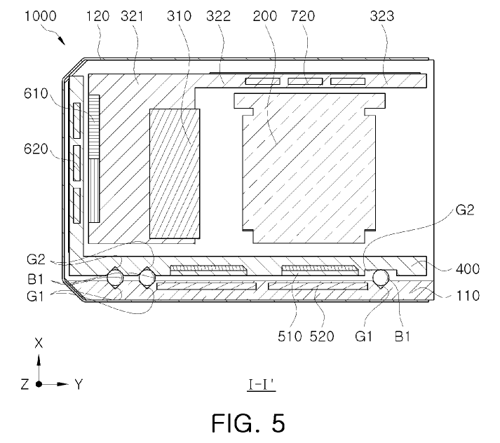

FIG. 4 is a plan diagram illustrating OIS operation in the X-axis direction and AF operation in the Y-axis direction of a camera module 1000 according to an embodiment. FIG. 5 is a cross-sectional diagram taken along line I-I’ in FIG. 1.

Referring to FIGS. 4 and 5, the camera module 1000 may include a housing 110, a carrier 400, a prism holder 320, and a lens module 200.

The housing 110 may accommodate the carrier 400 therein. The carrier 400 may be supported by the housing 110 and may be disposed to move in the first direction (Z-axis direction) with respect to the housing 110. The housing 110 may include a first guide groove G1 formed on a surface facing one surface of the carrier 400. The carrier 400 may include a second guide groove G2 facing the first guide groove G1. A first ball member B1 may be disposed between the first guide groove G1 and the second guide groove G2. The first ball member B1 may guide the linear movement of the carrier 400.

The camera module 1000 may include a first driver 500 moving the carrier 400 in the first direction (Z-axis direction). The first driver 500 may include a first coil 520 disposed in the housing 110. The first driver may also include a first magnet 510 disposed in the carrier 400 to face the first coil 520. When current is applied to the first coil 520, the carrier 400 may be driven in the first direction (Z-axis direction) by electromagnetic interaction between the first coil 520 and the first magnet 510. Through the movement of the carrier 400 as above, optical image stabilization (OIS) in the Z-axis direction may be implemented.

Referring to FIG. 5, the second guide groove G2 may be disposed as a plurality of guide grooves G2, and the plurality of second guide grooves G2 may be spaced apart from each other on both sides with respect to the first magnet 510 on the one surface of the carrier 400 in the third direction (Y-axis). The number of second guide grooves G2 disposed on one side with respect to the first magnet 510 and the number of second guide grooves G2 disposed on the other side may be different.

For example, with respect to the first magnet 510, one side of the carrier 400 may be adjacent to the prism holder 320. The other side of the carrier 400 may be adjacent to the lens module 200. The number of second guide grooves G2 disposed on one side of the carrier 400 may be greater than the number of second guide grooves G2 disposed on the other side of the carrier 400. Accordingly, by disposing a greater number of second guide grooves G2 and first ball members B1 on the prism holder 320 side, which includes the reflective member 310 having a relatively greater weight, stable support and operation considering the center of gravity of the carrier 400 may be performed.

The first ball members B1 disposed on one side of the carrier 400 may be in four-point contact between the first guide groove G1 and second guide groove G2. Also, the first ball member B1 disposed on the other side of the carrier 400 may be in three-point contact between the first guide groove G1 and second guide groove G2. By this structure, the ball members B1 may be prevented from being inserted or caught during operation.

The prism holder 320 may be supported by the carrier 400. The prism holder 320 may be disposed to move in the second direction (X-axis direction) perpendicular to the first direction (Z-axis direction) with respect to the carrier 400.

The prism holder 320 may include a mounting portion 321 in which a reflective member 310 is disposed. The prism holder 320 may also include an extension portion 322 extending from the mounting portion 321 in the third direction (Y-axis direction) and facing the lens module 200. The prism holder 320 may be supported by the plurality of second ball members B2 disposed between the carrier 400 and the prism holder 320. The prism holder 320 may linearly move in the second direction (X-axis direction) by the second ball member B2.

The camera module 1000 may include a second driver 600 moving the prism holder 320 in the second direction (X-axis). The second driver 600 may include a second coil 620 disposed in the carrier 400. Also, the second driver may include a second magnet 610 disposed in the prism holder 320 to face the second coil 620. By controlling current applied to the second coil 620, the prism holder 320 may move in the second direction (X-axis direction). The movement of the prism holder 320 may perform an optical image stabilization (OIS) function together with the movement of the carrier 400. That is, the shaking in the second direction (X-axis direction) may be corrected through the linear movement of the prism holder 320.

The lens module 200 may be supported by the prism holder 320. Specifically, the lens module 200 may be supported by the extension portion 322 of the prism holder 320. The lens module 200 may be disposed to move in the third direction (Y-axis direction) perpendicular to the first direction (Z-axis direction) and the second direction (X-axis direction) with respect to the prism holder 320.

The lens module 200 may include a lens barrel 210. The lens barrel 210 may include at least one lens aligned in the third direction (Y-axis). Also, the lens module 200 may include a lens holder 220 including the lens barrel 210 mounted thereon. The lens module 200 may be supported by a plurality of third ball members B3 disposed between the extension portion 322 of the prism holder 320 and the lens holder 220. The lens module 200 may linearly move in the third direction (Y-axis direction) by the third ball member B3.

The camera module 1000 may include a third driver 700 moving the lens module 200 in the third direction (Y-axis direction). The third driver 700 may include a third coil 720 disposed in the extension portion 322 of the prism holder 320. Also, the third driver 700 may include a third magnet 710 disposed in the lens holder 220 of the lens module 200 to face the third coil 720. When current is applied to the third coil 720, electromagnetic force may be generated. By the generated electromagnetic force, the lens module 200 may move in the third direction (Y-axis) and may perform an autofocus (AF) function. When the optical image stabilization (OIS) function is operated, the carrier 400 and prism holder 320 may move, and in this case, the lens module 200 may also move together therewith, which may improve accuracy of control over the autofocus (AF) function operation. That is, as the autofocus (AF) function of the lens module is operated while the shake prevention (OIS) function of the reflective module 300 is performed, accuracy of the control may be improved as compared to when operated separately.

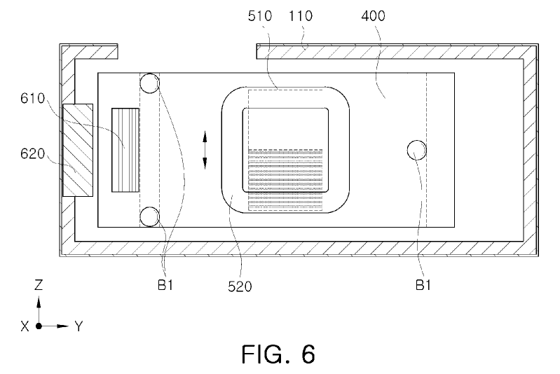

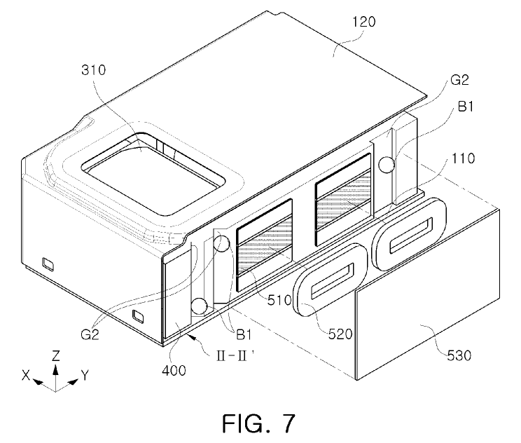

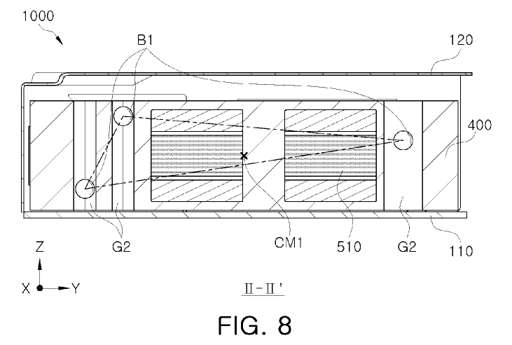

FIG. 6 is a diagram illustrating OIS operation in the Z-axis direction of a camera module 1000 according to an embodiment. FIG. 7 is a cross-sectional perspective diagram taken along line II-II’ in FIG. 1. FIG. 8 is a cross-sectional diagram taken along line II-II’ in FIG. 1. FIG. 9 is a cross-sectional diagram taken along line III-III’ in FIG. 1.

Referring to FIGS. 6, 7, 8, and 9, along with FIG. 4, the camera module 1000 may include a structure for optical image stabilization (OIS) in the first direction (Z-axis direction).

The carrier 400 may be supported by the housing 110 and may be disposed to move in the first direction (Z-axis direction) with respect to the housing 110.

The first direction (Z-axis direction) movement of the carrier 400 may be controlled by the first driver 500. The first driver 500 may include a first coil 520 disposed on the housing 110, and a first magnet 510 disposed on the carrier 400 to face the first coil 520. When current is applied to the first coil 520, the carrier 400 may receive driving force in the first direction by electromagnetic interaction between the magnetic field generated in the first coil 520 and the magnetic field of the first magnet 510. For example, the Lorentz force may act as the driving force. The first yoke 530 may be disposed on the outer side of the first coil 520. The first yoke 530 may form a path for the magnetic field, thereby improving driving efficiency.

For stable linear movement of the carrier 400, a plurality of first ball members B1 may be disposed between the housing 110 and the carrier 400. The housing 110 may include a first guide groove G1 formed on a surface facing one surface of the carrier 400. The carrier 400 may include a second guide groove G2 facing the first guide groove G1. The first ball member B1 may be disposed between the first guide groove G1 and the second guide groove G2. The first ball member B1 may reduce friction between the carrier 400 and the housing 110 through rolling. Accordingly, the carrier 400 may be allowed to move smoothly.

The first ball member B1 may include a plurality of units. For example, referring to FIG. 9, the first ball member B1 may include three first ball members B1-1, B1-2, and B1-3, disposed in three first guide grooves G1-1, G1-2, and G1-3, respectively.

Referring to FIG. 8, on a cross-sectional surface passing through the plurality of first ball members B1, the center of gravity CM1 of the carrier 400 may be positioned within an imaginary triangle connecting centers of the plurality of first ball members B1. This arrangement may prevent the carrier 400 from tilting or swaying in a specific direction when the carrier 400 moves. Accordingly, stable linear movement may be ensured.

In an embodiment, the first ball member B1 may be formed of a material having high hardness and wear resistance. For example, the first ball member B1 may be ceramic or plastic resin. However, an embodiment thereof is not limited thereto.

The first guide groove G1 and the second guide groove G2 may be configured to guide the movement path of the first ball member B1. The first guide groove G1 may be formed on a surface of the housing 110 facing the carrier 400. The second guide groove G2 may be formed on a surface of the carrier 400 facing the housing 110. A plurality of the first guide grooves G1 and a plurality of the second guide grooves G2 may be provided. The first guide groove G1 and the second guide groove G2 may have a shape extending in the first direction (Z-axis direction), which is the movement direction of the carrier 400.

Referring to FIG. 9, a plurality of the first guide grooves G1 may be provided. For example, the first guide groove G1 may include three first guide grooves G1-1, G1-2, and G1-3, spaced apart from each other. The lengths in the first direction (Z-axis direction) of the plurality of first guide grooves G1 may be different. For example, the length h1 of the first guide groove G1-1 and the length h2 of the first guide groove G1-2 may be different from the length h3 of the first guide groove G1-3. The difference in length may limit the maximum range of movement of the carrier 400. Alternatively, stable support may be provided at a specific position.

Referring to FIG. 8, the plurality of second guide grooves G2 may be spaced apart from each other on both sides in the third direction (Y-axis direction) with respect to the first magnet 510 on the one surface of the carrier 400. The number of second guide grooves G2 disposed on one side with respect to the first magnet 510 and the number of second guide grooves G2 disposed on the other side may be different from each other. For example, as illustrated in FIG. 8, two second guide grooves G2 may be disposed on the left side of the first magnet 510, and one second guide groove G2 may be disposed on the right side. The asymmetrical arrangement may consider the weight distribution of the carrier 400 and other components mounted on the carrier 400. Accordingly, the overall weight may be balanced and the moment occurring during operation may be offset.

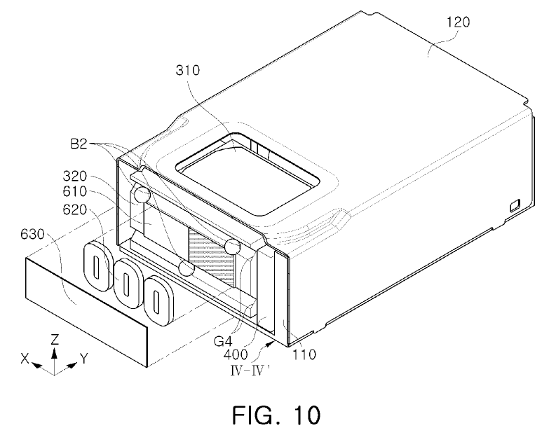

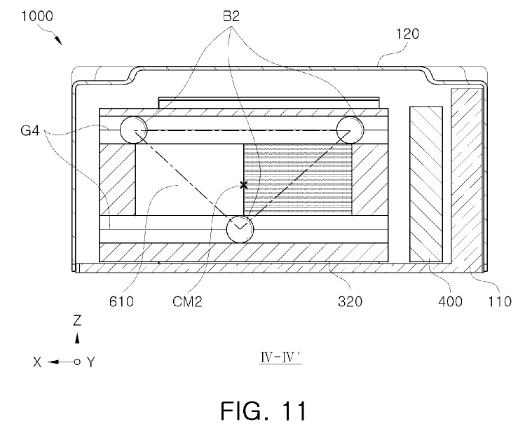

FIG. 10 is a cross-sectional perspective diagram taken along line IV-IV’ in FIG. 1. FIG. 11 is a cross-sectional diagram taken along line IV-IV’ in FIG. 1.

Referring to FIGS. 10 and 11, a prism holder 320 may be disposed to move in the second direction (X-axis direction) with respect to the carrier 400. The prism holder 320 may be configured to support the reflective member 310. By moving the prism holder 320 in the second direction (X-axis direction), an optical image stabilization (OIS) function in the second direction (X-axis direction) of the camera module 1000 may be implemented.

The carrier 400 may include a third guide groove on a surface facing the prism holder 320. The prism holder 320 may include a fourth guide groove G4 at a position facing the third guide groove of the carrier 400. The third guide groove and the fourth guide groove G4 may have shapes extending in the second direction (X-axis direction). A plurality of the third guide grooves and a plurality of the fourth guide grooves G4 may be formed.

The second ball member B2 may be disposed between the third guide groove of the carrier 400 and the fourth guide groove G4 of the prism holder 320. The second ball member B2 may roll. The rolling of the second ball member B2 may guide the prism holder 320 to move precisely with low friction with respect to the carrier 400. A plurality of the second ball members B2 may be provided. The plurality of second ball members B2 may support the prism holder 320 to maintain a stable posture during movement.

Referring to FIG. 11, on a cross-sectional surface passing through the plurality of second ball members B2, the center of gravity CM2 of the reflective module may be positioned within an imaginary triangle formed by connecting centers of the plurality of second ball members B2 with imaginary lines. The arrangement of the center of gravity CM may reduce the moment which may occur when the reflective module is driven in the second direction (X-axis direction). Accordingly, operating stability of the reflective module may be improved. Also, the power consumption required for operation may be reduced.

The fourth guide grooves G4 may be spaced apart from each other on both sides in the first direction (Z-axis direction) with respect to the second magnet 610 on one surface of the prism holder 320. With respect to the second magnet 610, the number of second ball members B2 disposed in the fourth guide groove G4 on one side may be greater than the number of second ball members B2 disposed in the fourth guide groove G4 on the other side. For example, as illustrated in FIG. 11, two second ball members B2 may be disposed on the upper side, and one second ball member B2 may be disposed on the lower side, thereby forming a three-point support structure. In an embodiment, the number of second ball members B2 disposed in the fourth guide groove G4 on one side with respect to the second magnet 610 may be two. The number of second ball members B2 disposed in the fourth guide groove G4 on the other side may be one.

In an embodiment, the second ball member B2 may be formed of a material having high hardness and wear resistance. For example, the second ball member B2 may be ceramic or plastic resin. However, an embodiment thereof is not limited thereto.

In an embodiment, a second driver 600 moving the prism holder 320 in the second direction (X-axis direction) may be provided. The second driver 600 may include a second magnet 610 and a second coil 620. The second driver 600 may generate a driving force to the prism holder 320 using electromagnetic force. The second driver may control the movement of the prism holder 320 in the second direction (X-axis direction).

The second coil 620 may be disposed in the carrier 400. The second magnet 610 may be disposed in the prism holder 320. The second magnet 610 may be disposed to face the second coil 620. When current is applied to the second coil 620, electromagnetic interaction with the second magnet 610 may occur according to Fleming’s left-hand rule. Due to this electromagnetic interaction, the prism holder 320 may be forced to move in the second direction (X-axis direction).

In an embodiment, the second driver may further include a second yoke 630. The second yoke 630 may be disposed on an outer side of the second coil 620 from the second magnet 610 and may form a magnetic circuit. The second yoke 630 may focus the magnetic field generated by the second magnet 610. The second yoke 630 may reduce leakage flux. The second yoke 630 may improve the driving efficiency of the second driver.

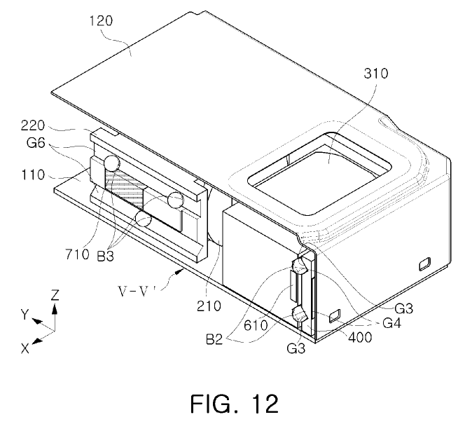

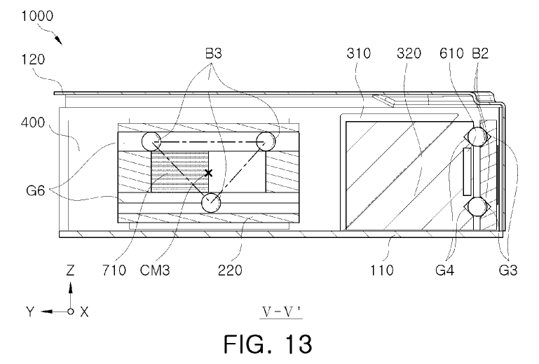

FIG. 12 is a cross-sectional perspective diagram taken along line V-V’ in FIG. 1. FIG. 13 is a cross-sectional diagram taken along line V-V’ in FIG. 1.

Referring to FIGS. 12 and 13, a lens holder 220 may be supported by an extension portion of the prism holder 320. The lens holder 220 may be disposed to move in the third direction (Y-axis direction).

The lens holder 220 may include a sixth guide groove G6 on a surface facing the extension portion of the prism holder 320. The sixth guide groove G6 may guide movement of the lens holder 220 in the third direction (Y-axis direction). A plurality of the sixth guide grooves G6 may be formed. Each of the plurality of sixth guide grooves G6 may have a shape extending in the third direction (Y-axis direction).

In an embodiment, the extension portion of the prism holder 320 may include a fifth guide groove formed on a surface facing the lens module 200. A plurality of the fifth guide grooves may be provided. The fifth guide groove may have a shape extending in the third direction (Y-axis direction).

The third ball member B3 may be disposed between the lens holder 220 and the prism holder 320. The third ball member B3 may function to smoothly guide the linear movement of the lens holder 220. The third ball member B3 may reduce friction through rolling contact, thereby enabling precise autofocus (AF) operation.

The third ball member B3 may be disposed between the fifth guide groove formed in the extension portion of the prism holder 320 and the sixth guide groove G6 formed in the lens holder 220. The lens holder 220 may be stably supported by the plurality of third ball members B3. When the lens holder 220 moves by the driving force of the third driver 700, the third ball member B3 may roll along the sixth guide groove G6. The third ball member B3 may implement movement in the third direction (Y-axis direction) of the lens holder 220.

In an embodiment, a plurality of the third ball members B3 may be provided. For example, the third ball member B3 may be formed of ceramic or plastic resin. However, an embodiment thereof is not limited thereto.

Referring to FIGS. 12 and 13, along with FIG. 3, the fifth guide grooves G5 may be disposed on one surface of the extension portion, spaced apart from each other in the first direction (Z-axis direction) on both sides with respect to the third magnet 710. The number of third ball members B3 disposed in the fifth guide groove G5 on one side (upper side) with respect to the third magnet 710 may be greater than the number of third ball members B3 disposed in the fifth guide groove on the other side (lower side).

The center of gravity CM3 of the lens module 200 may represent the center of mass of the lens module 200. The position of the center of gravity CM3 may be considered for stable operation of the lens module 200. The arrangement of the center of gravity CM3 may contribute to suppressing tilting or vibration occurring during operation.

FIG. 13 may illustrate a cross-sectional surface passing through the plurality of third ball members B3. The center of gravity CM3 of the lens module 200 may be positioned within an imaginary triangle formed by connecting centers of the plurality of third ball members B3 with imaginary lines. This arrangement may prevent moment when the lens module 200 moves in the Y-axis direction. Accordingly, stable linear movement of the lens module 200 may be ensured.

As the center of gravity CM3 of the lens module 200 is positioned within the triangle formed by the third ball member B3, which is the supporting point, the lens module 200 may maintain a stable position even under external impact or rapid acceleration and deceleration, which may improve precision and responsiveness of the autofocus (AF) function. Accordingly, the camera module 1000 may ensure high-quality imaging performance.

According to the aforementioned embodiments, in the camera module, the lens module may move together during OIS operation of the reflective member, such that accuracy of OIS and AF operation control may improve.

Also, in the camera module, OIS may be implemented by linear movement of the reflective member in the direction of two axes perpendicular to each other, such that optical axis alignment may be easily performed during OIS and AF operation.

Also, as the OIS and AF drivers are disposed on the side surface, the thickness of the camera module may be reduced.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a housing;
a carrier disposed on the housing and configured to move in a first direction with respect to the housing;
a prism holder disposed on the carrier and configured to move in a second direction perpendicular to the first direction with respect to the carrier;
a lens module disposed on the prism holder and configured to move in a third direction perpendicular to the first and second directions with respect to the prism holder.

2. The camera module of claim 1, wherein the lens module comprises a lens barrel comprising at least one lens aligned in the third direction, and a lens holder on which the lens barrel is mounted.

3. The camera module of claim 1,
wherein the housing comprises a first guide groove formed on a surface facing one surface of the carrier,
wherein the carrier comprises a second guide groove facing the first guide groove, and
wherein a first ball member is disposed between the first guide groove and the second guide groove.

4. The camera module of claim 3,
wherein the first guide groove is disposed as a plurality of first guide grooves and the second guide groove is disposed as a plurality of second guide grooves, and each of the plurality of first guide grooves and the plurality of second guide grooves has a shape extending in the first direction, and
wherein lengths in the first direction of the plurality of first guide grooves are different from each other.

5. The camera module of claim 4, further comprising a first driver configured to move the carrier in the first direction,
wherein the first driver comprises a first coil disposed in the housing, and a first magnet disposed in the carrier to face the first coil.

6. The camera module of claim 5,
wherein the plurality of second guide grooves are spaced apart from each other in the third direction on both sides of the carrier with respect to the first magnet on the one surface of the carrier, and
wherein a number of second guide grooves disposed on one side with respect to the first magnet and a number of second guide grooves disposed on another side are different.

7. The camera module of claim 6,
wherein, with respect to the first magnet, the one side of the carrier is adjacent to the prism holder, and the other side of the carrier is adjacent to the lens, and
wherein the number of the second guide grooves disposed on the one side of the carrier is greater than the number of the second guide grooves disposed on the other side of the carrier.

8. The camera module of claim 1, wherein the prism holder comprises a mounting portion in which a reflective member is disposed, and an extension portion extending from the mounting portion in the third direction and facing the lens module.

9. The camera module of claim 8,
wherein the carrier comprises a third guide groove formed on a surface facing the prism holder,
wherein the prism holder comprises a fourth guide groove facing the third guide groove, and
wherein a second ball member is disposed between the third and fourth guide grooves.

10. The camera module of claim 9, wherein the third guide groove is disposed as a plurality of third guide grooves and the fourth guide groove is disposed as a plurality of fourth guide grooves, and each of the plurality of third guide grooves and the plurality of fourth guide grooves has a shape extending in the second direction.

11. The camera module of claim 10, further comprising a second driver configured to move the prism holder in the second direction,
wherein the second driver comprises a second coil disposed in the carrier, and a second magnet disposed in the prism holder to face the second coil.

12. The camera module of claim 11,
wherein the second ball member is disposed as a plurality of second ball members,
wherein the plurality of fourth guide grooves are spaced apart from each other on both sides in the first direction with respect to the second magnet on one surface of the prism holder, and
wherein a number of second ball members disposed in the fourth guide groove on one side with respect to the second magnet is greater than a number of second ball members disposed in the fourth guide groove on another side.

13. The camera module of claim 8,
wherein the extension portion comprises a fifth guide groove formed on a surface facing the lens module,
wherein the lens module comprises a sixth guide groove facing the extension portion, and
wherein a third ball member is disposed between the fifth guide groove and the sixth guide groove.

14. The camera module of claim 13, wherein the fifth guide groove is disposed as a plurality of fifth guide grooves and the sixth guide groove is disposed as a plurality of sixth guide grooves, and each of the plurality of fifth guide grooves and the plurality of sixth guide grooves has a shape extending in the third direction.

15. The camera module of claim 14, further comprising:
a third driver configured to move the lens module in the third direction,
wherein the third driver comprises a third coil disposed in the extension portion, and a third magnet disposed in the lens module to face the third coil.

16. The camera module of claim 15,
wherein the third ball member is disposed as a plurality of third ball members,
wherein the plurality of fifth guide grooves are disposed on one surface of the extension portion, spaced apart from each other in the first direction on both sides with respect to the third magnet, and
wherein a number of third ball members disposed in the fifth guide groove on one side with respect to the third magnet is greater than a number of third ball members disposed in the fifth guide groove on another side.

17. A camera module, comprising:
a housing;
a reflective module disposed in the housing and configured to move in a first direction and a second direction perpendicular to the first direction; and
a lens module configured to move in the first direction and the second direction together with the reflective module, and configured to move in a third direction perpendicular to the first direction and the second direction with respect to the reflective module.

18. The camera module of claim 17, further comprising:
a carrier in which the reflective module is disposed;
a plurality of first ball members disposed between the housing and the carrier and configured to support the carrier;
a plurality of second ball members disposed between the carrier and the reflection module and configured to support the reflection module; and
a plurality of third ball members disposed between the reflection module and the lens module and configured to support the lens module,
wherein, on a cross-sectional surface passing through the plurality of first ball members, a center of gravity of the carrier is positioned within a triangle connecting centers of the plurality of first ball members.

19. The camera module of claim 18, wherein, on a cross-sectional surface passing through the plurality of second ball members, a center of gravity of the reflective module is positioned within a triangle connecting centers of the plurality of second ball members.

20. The camera module of claim 18, wherein, on a cross-sectional surface passing through the plurality of third ball members, a center of gravity of the lens module is positioned within a triangle connecting centers of the plurality of third ball members.
